(19) United States
(12) Patent Application Publication
(10) Pub. No.: US 2005/0182718 A1
(43) Pub. Date: Aug. 18, 2005

(54) Intra-call display of billing rate information

(75) Inventors: Philip Ted Kortum, Austin, TX (US); Barbara Engel Smith, San Antonio, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/777,774

(22) Filed: Feb. 12, 2004

(51) Int. Cl. G06F 17/60

(52) U.S. Cl. 705/40

(57) ABSTRACT

A real-time, cost-per-unit-time billing rate is determined for an in-progress telephone call of a wireless telephone. The real-time, cost-per-unit-time billing rate is displayed on a display of the wireless telephone during the in-progress telephone call.

### FIELD OF THE DISCLOSURE

The present disclosure relates to methods and systems for displaying billing information on a mobile telephone.

### DESCRIPTION OF THE RELATED ART

Many, if not most, users of mobile telephones only have a general idea of a cost of any particular call while they are making the call. A wireless telephone user can mentally estimate the cost of a telephone call if he/she knows specifics of his/her rate plan, a number of minutes he/she has remaining for specific portions of his/her rate plan, and his/her exact location and its relationship to a home network. Errors in mentally estimating the cost may occur if the user is roaming and/or using the wireless telephone during an unusual time for him/her.

Although many wireless telephones indicate whether a user is in an extended network area or a roaming area, the responsibility is on the user to have a full and accurate knowledge of his/her rate plan, and current information on how many minutes are available in potentially multiple categories. Some wireless companies offer this information over the Web, but require the user to access the Web to secure the information before they make a call. Further, the information becomes dated and stale once the user places the call since he/she could roam into another area or run out of a particular category of use minutes.

For many users, the first indication of the real cost of each call comes when they receive their billing statements at the end of a billing cycle. Users who either made calls without thinking about their costs or incorrectly estimated costs of one or more calls may be presented with unexpectedly-high charges on their bills. Unexpectedly-high bills can lead to customer dissatisfaction, which in turn can lead to churn (i.e. switching to another wireless telephone service provider).

At least one wireless provider offers a feature of generating and sending a text message, which indicates a number of peak minutes used, a number of off-peak minutes used, a number of weekend minutes used, and a number of mobile-to-mobile minutes used, to a subscriber's wireless telephone in response to the subscriber dialing #646. A feature is also available for generating and sending a text message, which indicates a current billing balance, a last payment amount and a last payment date, to a subscriber's wireless telephone in response to the subscriber dialing #225.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram of an embodiment of a system to provide real-time, cost-per-unit-time rate information during an in-progress telephone call;

FIG. 2 is a flow chart of an embodiment of a method of providing the real-time, cost-per-unit time rate information during an in-progress telephone call;

FIGS. 3(A-F) show examples of different screens which may be shown by the display;

FIG. 4 is a flow chart of an embodiment of a method of providing a message indicating a number of minutes used and/or available;

FIG. 5 shows an example of a minutes available message being displayed;

FIG. 6 is a flow chart of an embodiment of a method of providing a warning message indicating a number of minutes available; and

FIG. 7 shows an example of a warning message being displayed.

### DETAILED DESCRIPTION OF THE PREFERRED EMBODIMENTS

There is a need to provide wireless telephone service customers cost information while a call is in progress. To address this need and other needs, embodiments of the present disclosure provide wireless telephone service customers real-time, cost-per-unit-time rate information for wireless telephone calls while the calls are in-progress. The rate information is updated in real-time as a wireless telephone call progresses, and is provided without requiring an action of the user. If a customer is able to see the cost-per-unit-time rate information, he/she can self-manage his/her telephone bill by choosing to terminate the call earlier or stay on the call longer depending on the rate and the circumstance. This information and self-regulation can lead to higher customer satisfaction, particularly when the bill arrives and there are no surprises.

A wireless telephone service provider can provide the real-time, cost-per-unit- time rate information for free to the customer. Alternatively, the wireless telephone service provider can provide the real-time, cost-per-unit-time rate information for a fee to the customer, such as a monthly subscription service fee or a pay-per-use fee.

In addition to providing text messages such as SMS messages which include per call rate information, these same text messages or other text messages can also provide notifications and warnings/alerts for minutes used and/or minutes available for a billing cycle.

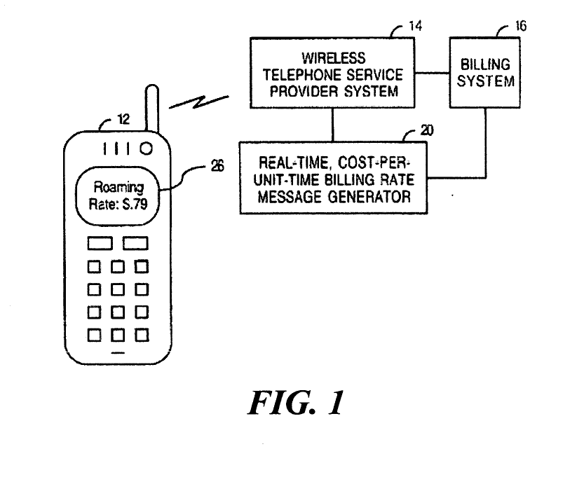

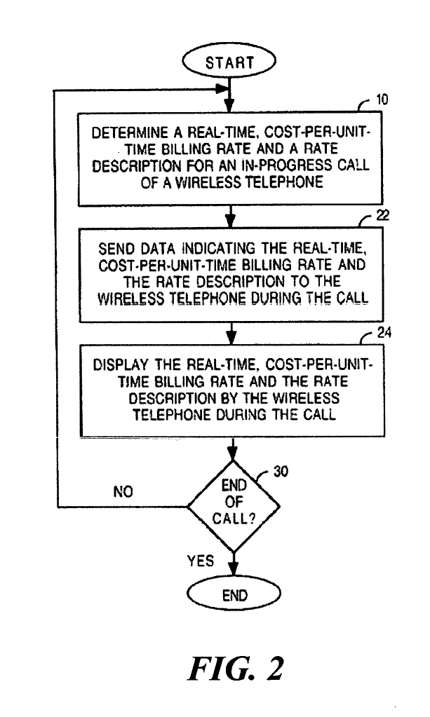

Embodiments of the present disclosure are described with reference to FIG. 1, which is a block diagram of an embodiment of a system to provide real-time, cost-per-unit-time rate information during an in-progress telephone call and FIG. 2, which is a flow chart of an embodiment of a method of providing the real-time, cost-per-unit time rate information during an in-progress telephone call.

As indicated by block 10, the method comprises determining a real-time, cost-per-unit-time billing rate, and optionally a rate description, for an in-progress telephone call of a wireless telephone 12. The in-progress telephone call is facilitated by a wireless telephone service provider system 14, which provides wireless telephone service for the wireless telephone 12. The wireless telephone 12 may be associated with either a calling party or a called party of the in-progress telephone call. The wireless telephone service provider system 14 communicates with a billing system 16 to account for usage of the wireless telephone 12, including usage associated with the in-progress telephone call, and to bill a subscriber of service for the wireless telephone 12 for the usage.

In one embodiment, the billing rate of the in-progress telephone call is determined by a node remote to the wireless telephone 12. The remote node comprises a real-time, cost-per-unit-time billing rate message generator 20 which determines the billing rate by accessing the billing system 16.

The billing rate depends on factors such as: (a) a particular access plan to which the user has subscribed for use of the wireless telephone 12; (b) a particular time of day at which the telephone call is taking place; (c) a particular day of week on which the telephone call is taking place; (d) whether or not the telephone call is taking place on a holiday; (e) a location of the wireless telephone, e.g. in a home area or a roaming area; (f) a type of telephone call, e.g. a mobile-to-mobile call, a family call, or a directory assistance call; and (g) whether or not any time remains in a relevant access category of the particular access plan.

The billing system 16 may indicate some users having a local calling plan, other users having a national calling plan, and still other users having an international calling plan. Each plan has an associated monthly access charge for an associated number of anytime minutes, night and weekend minutes, and optionally mobile-to-mobile minutes of access.

For example, a first local plan may have a monthly access charge of $29.99 for 300 anytime minutes and 5000 night and weekend minutes, a second local plan may have a monthly access charge of $49.99 for 800 anytime minutes and 5000 night and weekend minutes, a third local plan may have a monthly access charge of $149.99 for 2500 anytime minutes and 5000 night and weekend minutes, and a fourth local plan may have a monthly access charge of $199.99 for 3500 anytime minutes and 5000 night and weekend minutes.

Similarly, a first national plan may have a monthly access charge of $29.99 for 250 anytime minutes and 5000 night and weekend minutes, a second national plan may have a monthly access charge of $49.99 for 700 anytime minutes and 5000 night and weekend minutes, a third national plan may have a monthly access charge of $149.99 for 2000 anytime minutes and 5000 night and weekend minutes, and a fourth national plan may have a monthly access charge of $199.99 for 3000 anytime minutes and 5000 night and weekend minutes.

If use of the wireless telephone exceeds the allotted number of minutes in a particular access category, the subscriber is billed an additional per-minute charge. For example, the first local and national plans may charge $0.45 per minute for additional minutes, the second local and national plans may charge $0.39 per minute for additional minutes, the third local and national plans may charge $0.35 per minute for additional minutes, and the fourth local and national plans may charge $0.29 per minute for additional minutes.

For any of the local plans, use of the wireless telephone 12 outside of a home area incurs an additional roaming charge. In one embodiment, the roaming charge is $0.79 per minute for each of the first, second, third and fourth local plans.

Based on the particular plan for the wireless telephone 12, the message generator 20 determines the billing rate to indicate a billing rate of the in-progress telephone call beyond the monthly access charge. For example, the billing rate may indicate a cost-per-minute for a particular minute of use. The cost-per-minute may be determined either after a minute of use has completed, during a current minute of use, or at the beginning of a minute of use.

As indicated by block 22, the method comprises sending data indicating the real-time, cost-per-unit-time billing rate, and optionally the rate description, from the remote node comprising the message generator 20 to the wireless telephone 12 during the in-progress telephone call. The data is sent wirelessly via the wireless telephone service provider system 14, and is received by a receiver of the wireless telephone 12.

As indicated by block 24, the method comprises displaying the real-time, cost-per-unit-time billing rate, and optionally the rate description, on a display 26 of the wireless telephone 12 during the in-progress telephone call. For purposes of illustration and example, the display 26 is shown to simultaneously display a per-minute billing rate of $0.79 and a rate description of “roaming” in the case that the wireless telephone 12 is used in accordance with a local access plan and is located outside a home area while conducting the in-progress telephone call. After seeing the rate and description on the display 26, the user of the wireless telephone 12 may decide to end the call so as not to incur an undesirably large charge beyond the monthly access charge.

As indicated by block 30, the acts indicated by blocks 10, 22 and 24 may be repeated while the call is still in-progress. By repeating these acts, the cost-per-unit-time billing rate and rate description information are updated and displayed to the user in real time over the course of the telephone call. For instance, after determining and displaying a first real-time, cost-per-unit-time billing rate and a first rate description, a second real- time, cost-per-unit time billing rate and a second rate description can be determined by the message generator 20, communicated to the wireless telephone 12 in a second message, and displayed by the display 20 during the telephone call. If conditions have not changed, the second real-time, cost-per-unit time billing rate and the second rate description are the same as the first real-time, cost-per-unit time billing rate and the first rate description. If conditions have changed, the second real-time, cost-per-unit time billing rate and the second rate description may differ from the first real-time, cost-per-unit time billing rate and the first rate description. Examples of changing conditions include, but are not limited to, traveling from a home area to a roaming area or vice versa, using a last allotted minute in a particular access category, and a time of day crossing from a day to night or vice versa.

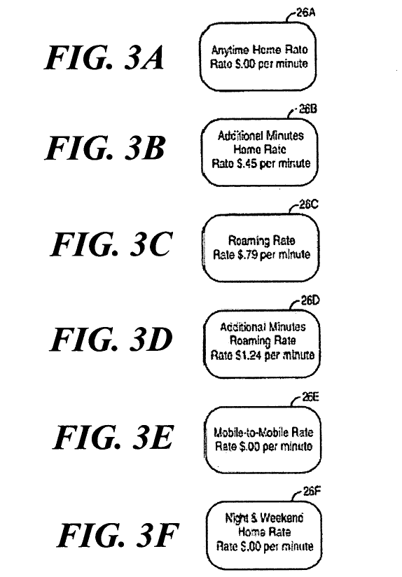

FIGS. 3(A-F) shows examples of different screens which may be shown by the display 26. FIG. 3A shows a display 26A indicating a rate description of an anytime home rate (assuming the user has remaining anytime minutes for the month, and is located within a home area), and its associated rate of $0.00 per minute. FIG. 3B shows a display 26B indicating a rate description of an additional minutes home rate (assuming the user has used all of his/her anytime minutes for the month, and is within a home area), and its associated rate of $0.45 per minute. FIG. 3C shows a display 26C indicating a rate description of a roaming rate (assuming the user has remaining anytime minutes for the month, but is within a roaming area), and its associated rate of $0.79 per minute. FIG. 3D shows a display 26D indicating a rate description of an additional minutes roaming rate (assuming the user has used all of his/her anytime minutes for the month, and is within a roaming area), and its associated rate of $0.45+$0.79=$1.24 per minute. FIG. 3E shows a display 26E indicating a rate description of a mobile-to-mobile rate, and its associated rate of $0.00 per minute. FIG. 3F shows a display 26F indicating a rate description of a night and weekend rate (assuming the user is making the call on a night or weekend, and is located within a home area), and its associated rate of $0.00 per minute.

There are several higher order features that can be provided in addition to the billing rate to gain additional value and revenue. The message generator 20 can determine and the display 26 can display a total cost of the call in addition to the billing rate. The total cost can be incremented on the display 26 as the call progresses. Further, the message generator 20 can determine and the display 26 can display a total amount of the current billing cycle. The total amount of the current billing cycle can be incremented on the display 26 as the call progresses. Still further, the wireless telephone 12 can generate an audible tone to signal to the user that a rate-changing event has occurred.

Optionally, the message generator 20 can determine a number of minutes used and/or a number of minutes available (including rollover minutes) in the current billing cycle, and send a message such as an Short Message Service (SMS) alert indicating same for reception by the wireless telephone 12. The message can be sent either during an in- progress telephone call, at a subscriber-specified time and frequency (e.g. daily or weekly), or in response to usage in any of the pre-established minute categories exceeding a subscriber-set threshold. The notification may provide the following information: anytime minutes used, nights and weekends minutes used, total anytime minutes remaining for the billing cycle, total rollover minutes available, and days remaining in a billing period.

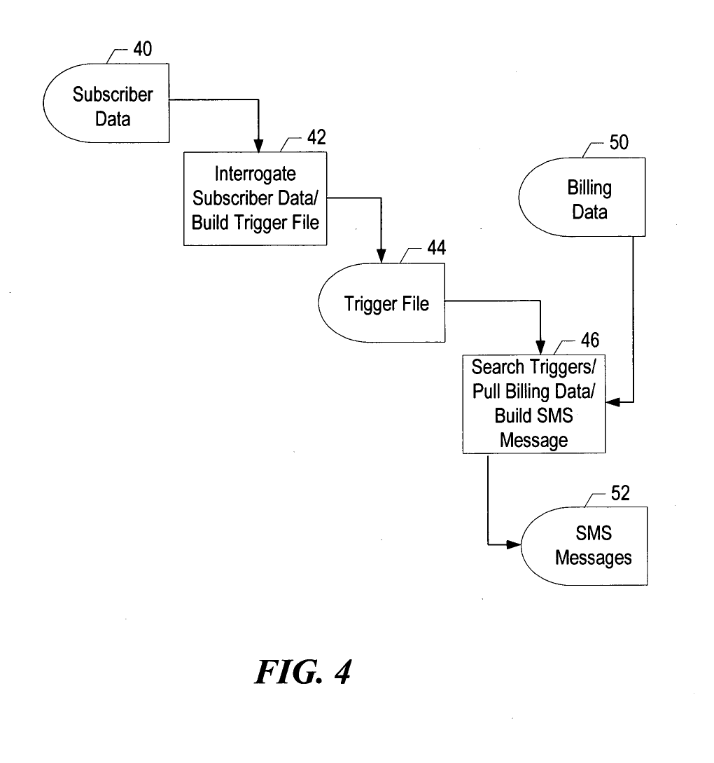

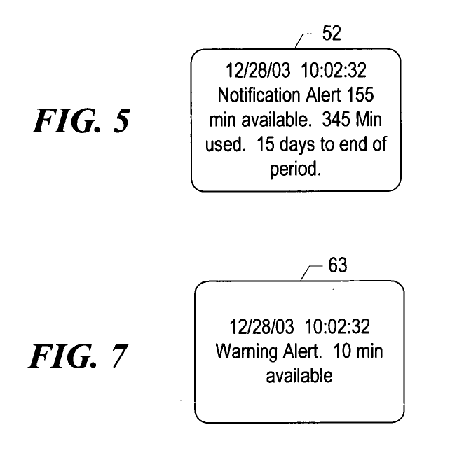

FIG. 4 is a flow chart of an embodiment of a method of providing a message indicating a number of minutes used and/or available. The subscriber can access a Web site of the wireless telephone service provider to set user-defined parameters for time and frequency of notification, and thresholds for warning messages. The user-defined parameters are stored in a subscriber database 40. As indicated by block 42, periodic interrogations of the subscriber database 40 are run to identify a current list of subscribers that request minutes available messaging, and generate a trigger file 44 based thereon. As indicated by block 46, when a trigger condition is encountered (time and frequency) based on the trigger file 44, billing data 50 from the billing system 16 is accessed to create a textual, SMS message 52 which includes or is based on the minutes available data, and the number of days remaining in the billing period. The SMS message 52 is communicated to the wireless telephone 12 and displayed by the display 26. FIG. 5 shows an example of the SMS message 52 being displayed by the display 26.

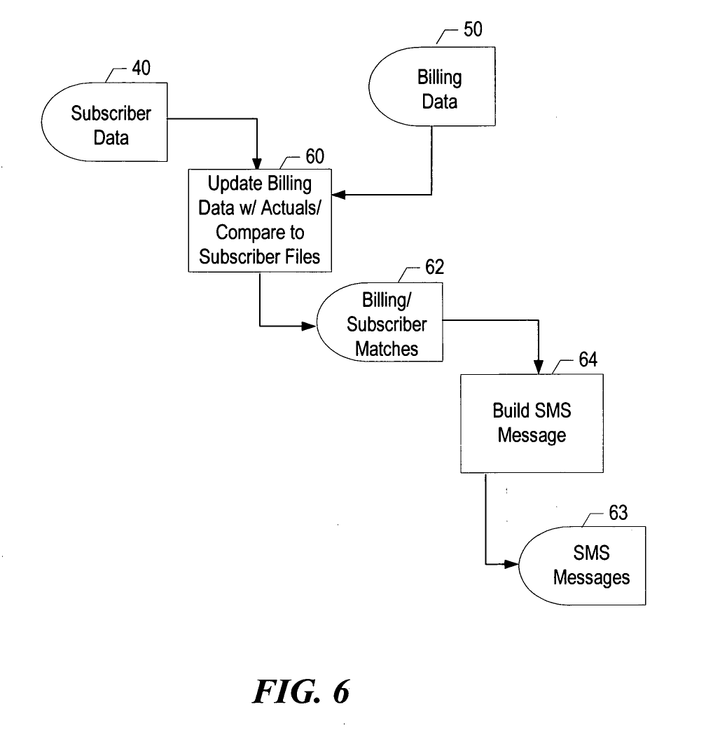

FIG. 6 is a flow chart of an embodiment of a method of providing a warning message indicating a number of minutes available. As indicated by block 60, at a time when a carrier's system updates a subscriber's usage data, the subscriber database 40 is interrogated to determine if a trigger condition based on a threshold has occurred. Upon noting a match 62 for a trigger condition, a textual, SMS message 63 which indicates a warning is generated as indicated by block 64. The SMS message 63 is communicated to the wireless telephone 12 and displayed by the display 26. FIG. 7 shows an example of the SMS message 63 being displayed by the display 26.

The messages described with reference to FIGS. 4 to 7 may provide actionable information. These actions may include a request by the subscriber to move his/her plan to one that provides more minutes.

The methods described herein can be implemented using computer-readable program code stored by a computer-readable medium. The computer-readable program code causes a computer system to perform acts described herein. Examples of the computer-readable medium include, but are not limited to, an electronic medium such as an electronic memory, a magnetic medium such as a hard disk or a floppy disk, and an optical medium such as an optical disk.

It will be apparent to those skilled in the art that the disclosed embodiments may be modified in numerous ways and may assume many embodiments other than the particular forms specifically set out and described herein. For example, acts involved in determining the billing rate and the billing description may be performed by the wireless telephone 12 rather than the message generator 20, in which case the message generator 20 may be omitted.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method comprising:
determining a first real-time, cost-per-unit-time billing rate for an in-progress telephone call of a wireless telephone; and
displaying the first real-time, cost-per-unit-time billing rate on a display of the wireless telephone during the in-progress telephone call.

2. The method of claim 1 further comprising, after said displaying the first real-time, cost-per-unit time billing rate:
determining a second real-time, cost-per-unit-time billing rate for the in-progress telephone call of the wireless telephone; and
displaying the second real-time, cost-per-unit-time billing rate on the display of the wireless telephone during the in-progress telephone call.

3. The method of claim 2 wherein the second real-time, cost-per-unit-time billing rate differs from the first real-time, cost-per-unit-time billing rate.

4. The method of claim 1 wherein the first real-time, cost-per-unit-time billing rate comprises a cost-per-minute rate.

5. The method of claim 1 further comprising:
determining a first rate description associated with the first real-time, cost-per-unit-time billing rate; and
displaying the first rate description on the display of the wireless telephone during the in-progress telephone call.

6. The method of claim 5 wherein the first rate description and the first real-time, cost-per-unit-time billing rate are simultaneously displayed by the display of the wireless telephone.

7. The method of claim 1 wherein said determining is performed by a node remote to the wireless telephone, the method further comprising:
sending data indicating the first real-time, cost-per-unit-time billing rate from the node to the wireless telephone during the in-progress telephone call.

8. The method of claim 1 further comprising:
displaying a number of days remaining in a billing period on the display.

9. A wireless telephone comprising:
a display to display, during an in-progress telephone call, a first real-time, cost-per-unit-time billing rate for the in-progress telephone call.

10. The wireless telephone of claim 9 wherein the display is to display, after displaying the first real-time, cost-per-unit time billing rate but during the in-progress telephone call, a second real-time, cost-per-unit-time billing rate for the in-progress telephone call.

11. The wireless telephone of claim 10 wherein the second real-time, cost-per-unit-time billing rate differs from the first real-time, cost-per-unit-time billing rate.

12. The wireless telephone of claim 9 wherein the first real-time, cost-per-unit-time billing rate comprises a cost-per-minute rate.

13. The wireless telephone of claim 9 wherein the display is further to display a first rate description associated with the first real-time, cost-per-unit-time billing rate on the display of the wireless telephone during the in-progress telephone call.

14. The wireless telephone of claim 13 wherein the display is to simultaneously display the first rate description and the first real-time, cost-per-unit-time billing rate.

15. The wireless telephone of claim 9 further comprising:
a receiver to receive data indicating the first real-time, cost-per-unit-time billing rate from a remote node.

16. The wireless telephone of claim 9 wherein the display is further to display a number of days remaining in a billing period.

17. A system comprising:
a message generator to determine a first real-time, cost-per-unit-time billing rate for an in-progress telephone call of a wireless telephone, and to generate a first message having data which indicates the first real-time, cost-per-unit-time billing rate to the wireless telephone during the in-progress telephone call.

18. The system of claim 17 wherein after generating the first message, the message generator is to determine a second real-time, cost-per-unit-time billing rate for the in-progress telephone call of the wireless telephone, and to generate a second message having data which indicates the second real-time, cost-per-unit-time billing rate to the wireless telephone during the in-progress telephone call.

19. The system of claim 18 wherein the second real-time, cost-per-unit-time billing rate differs from the first real-time, cost-per-unit-time billing rate.

20. The system of claim 17 wherein the first real-time, cost-per-unit-time billing rate comprises a cost-per-minute rate.

21. The system of claim 17 wherein the message generator is to determine a first rate description associated with the first real-time, cost-per-unit-time billing rate, and wherein the data in the first message indicates the first rate description.

22. The system of claim 17 wherein the message generator is to generate a message indicating a number of days remaining in a billing period.
